(19) United States
(12) Patent Application Publication
(10) Pub. No.: US 2004/0007452 A1
(43) Pub. Date: Jan. 15, 2004

(54) Water purification: ion separation

(76) Inventors: William L. Warren, Stillwater, OK (US); Richard Stoltz, Plano, TX (US)

Correspondence Address: NEEDLE & ROSENBERG, P.C., SUITE 1000, 999 PEACHTREE STREET, ATLANTA, GA, 30309-3915, US

(21) Appl. No.: 10/301,550

(22) Filed: Nov. 21, 2002

Related U.S. Application Data
(60) Provisional application No. 60/335,592, filed on Dec. 5, 2001.

(51) Int. Cl. C02F 1/469; B01D 61/42

(52) U.S. Cl. 204/155; 204/554

(57) ABSTRACT

A method and apparatus are provided for fluid purification. A charged species from the fluid using, e.g., a Lorentz force. This creates a voltage, e.g., a Hall voltage that counteracts separation of the charged species from the fluid. This voltage is then discharged.

### CROSS-REFERENCE TO RELATED APPLICATIONS

This application claims priority from commonly assigned U.S. Provisional Application No. 60/335,592 filed in the names of Warren et al. This application is hereby incorporated by reference.

### BACKGROUND

The present invention is directed to a method and system for fluid purification. More particularly, the present invention is directed to a method and system for purifying fluid using ionic separation.

Quality water is a shared resource that is becoming increasingly scarce in both developed and developing countries, due to rapidly changing agricultural and industrial uses as well as to the rapid population increases being seen in arid regions of the world. Thus, much interest has been focused on the development of new technologies aimed at the economical purification of water from nontraditional sources. Sources of interest include saline waters, brackish waters, and sea water.

Water purification and desalination are focus areas of preventative defense and environmental security because they not only meet future global water demands but can be used for humanitarian assistance in water-starved regions.

Currently, there are several techniques for desalting brackish water or seawater including electrodialysis, reverse osmosis (RO), multistage flash distillation (MSF), and vapor compression. Each of these techniques requires intensive investments in capital and energy. Capital costs for these techniques are high even for brackish water because of the operating conditions of high pressure (1000 psi=6.9 MPa) for RO, or high temperature and moderate pressure (266° F.=130° C. and 40 psi=276 kPa gauge) for MSF and vapor compression.

The amount of energy used by the present desalting technologies is high relative to the minimum energy of separation of salt from seawater. The minimum free energy requirement for desalting seawater is 3.7 kWh/1000 gallons or 1.0 k m3 at 25° C. A typical brackish water RO unit operates at 1000 psi (6.9 MPa) pressure, 30% water recovery, and 70% pump efficiency consumes 33 kWh/1000 gallons (8.7 kWh/m3). At an average retail cost of $0.10/kWh, just the energy costs for that method of removing the salt from brackish water would be $3.30/1000 gallons ($0.87/m3).

Thus, there is a need for a technique for purifying a fluid with a minimal amount of energy.

### SUMMARY

It is therefore an object of the present invention to provide a method and apparatus for fluid purification with a minimal amount of energy.

The improvement described below uses technological revolutions in materials, computational fluid dynamics (CFD), and manufacturing applied to water technologies and can make large, cost-effective improvements in water quality and treatment. This approach deionizes any fluid medium (including water) and is called herein the “Lorentz Ionic Separation Apparatus” (LISA). The LISA process is a fundamentally orthogonal and scalable de-ionization technology (e.g., water desalination technology) that gains the following advantages when compared to such state-of-the-art ion separation technologies as reverse osmosis, distillation, and variants thereof:

LISA can be at least ten times more energy-efficient;

LISA can require less maintenance (virtually no fouling); LISA can have greater water throughput; and LISA can be more cost-effective.

LISA can be implemented to be used with any charged ionic species and in any fluid medium (gas, plasma, solutions, etc.).

The objects, advantages and features of the present invention will become more apparent when reference is made to the following description taken in conjunction with the accompanying drawings.

### BRIEF DESCRIPTION OF THE DRAWINGS

FIG. 1 illustrates an effect of a moving charge in the presence of a magnetic field;

FIGS. 2A and 2B illustrate how a current flow reacts to a magnetic field:

FIGS. 3A and 3B illustrate directions of electric and magnetic forces;

FIG. 4 illustrates a pseudo-virtual impactor;

FIG. 5 illustrates a three stage pseudo-virtual impactor;

FIG. 6 illustrates an exemplary apparatus for removing concentrated ions;

FIG. 7 illustrates an exemplary apparatus for separating ions from a fluid stream using Lorentz and electrophoretic forces;

FIG. 8 illustrates an exemplary magnetodialysis process;

FIGS. 9A-9C illustrates exemplary segmented electrode configurations; and

FIG. 10 illustrates an exemplary energy-recovery LC system.

### DETAILED DESCRIPTION

Understanding the kinetics and energetics of desalting, the effects of charge, and performing active control of the ionic separation surface can decrease energy consumption; simplify design, construction, and operation of deionization systems; overcome biofouling; and provide sizeable improvements in the ability to process in-line any harmful ionic contaminants (e.g., heavy metals, radioactive elements, salt, water hardeners) from any fluid stream.

According to exemplary embodiment, LISA is an approach based on the fusion of several technological advances. This approach takes any ionic species (dissolved minerals, radioactive elements, chromium, arsenic, salt, etc.) out of any fluid (brackish water, hard water, seawater, plasmas, gases, etc.). In the case of seawater desalination, LISA is quite different than RO processes, which take purified water out of the salt solution. The LISA process can remove dissolved ionic species or toxic chemicals from polluted water, or desalt seawater, with potentially 10 times less energy than state-of-the-art RO and at least 100 times less energy than seawater distillation. This new-to-the-world, energy-efficient process can be made possible by exploiting electromagnetics (the Lorentz force), virtual impactors, fluid dynamics, ion-selective membranes and/or porous walls, and can use energy recovery via magnetohydrodynamics (MHD) and net ionic currents in the separated fluidic streams.

To aid in understanding, several fundamentals regarding the Lorentz force and the Hall effect are explained.

The force exerted on a charged particle moving in a magnetic field is given by:

F=q(v×B)

where F is the force vector acting on the charged particle due to interaction with the magnetic field vector B, q is the scalar charge of the article, and v is the velocity vector of the charged particle perpendicular to the magnetic field B.

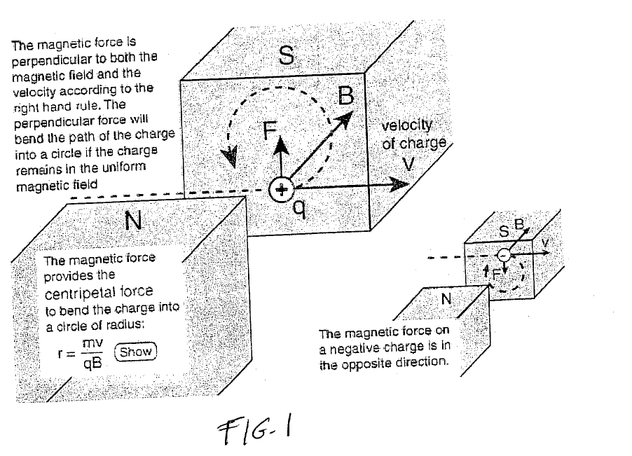

In essence, a charged particle moving in a magnetic field experiences a force proportional to its charge, its velocity, and the magnetic field strength. The force is directed at a right angle to both the particle velocity and the magnetic field directions; hence, the magnetic field causes the particle to gyrate around its direction. Positively charged particles (including electron holes) travel one direction, while negatively charged particles travel in the opposite direction. The force F on charge q moving through an external magnetic field B with velocity v is called the Lorentz force, as described by the equation above. FIG. 1A provides a graphical illustration.

The Lorentz force has been utilized for many applications, including cyclotrons, mass spectrometers, electric motors, loudspeakers, and generators. The Lorentz force can separate charged ions from fluidic media.

The Hall Effect

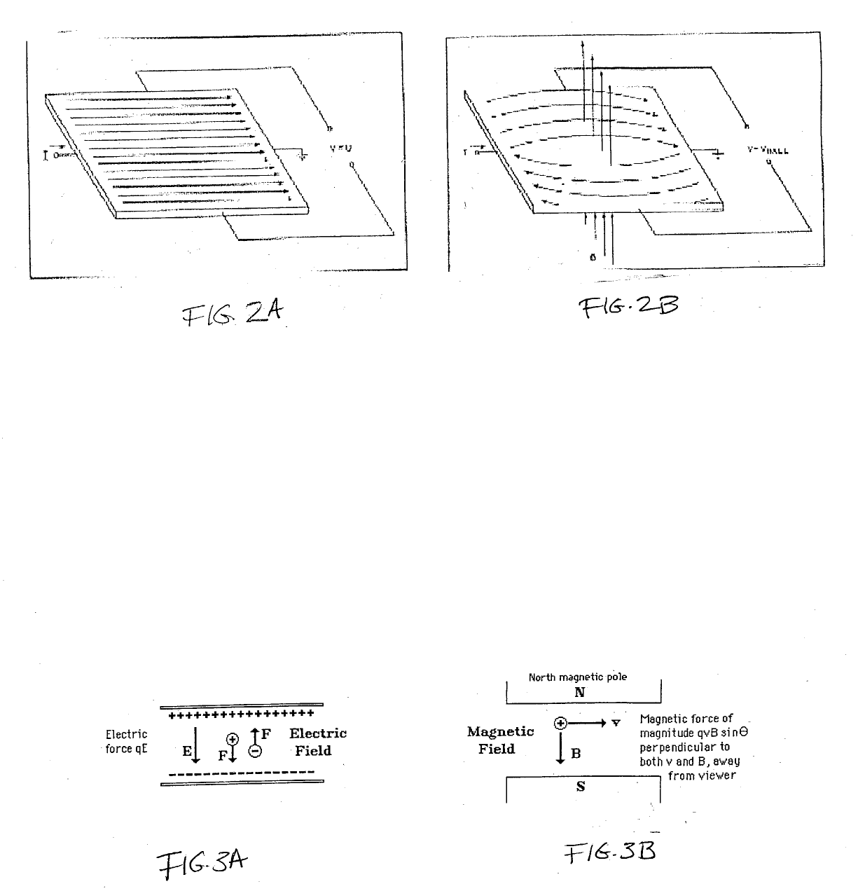

The Hall effect principally states that when a current-carrying conductor is placed within a magnetic field, a voltage is generated perpendicular to the direction of both the field and the flow of current. In FIG. 2A, a constant current is passed through a thin sheet of a conducting material. The sheet has measurement connections attached at right angles to the current flow. With no magnetic field, current distribution is uniform, and no potential difference exists at the output contacts. When a perpendicular magnetic field is present, as illustrated in FIG. 2B, the current flow is distorted. The uneven distribution of electron density creates a potential difference across the output terminals. This voltage is called the Hall voltage. The Hall voltage is a direct consequence of the Lorentz force; the separation of the ions and/or electronic charges by the magnetic field establishes the compensating Hall voltage.

The Lorentz Force Law for Electric and Magnetic Fields Combined

Either an electric field or a magnetic field can induce a force upon a charged particle. Both the electric field and magnetic field contributions can be defined from the Lorentz Force Law:

F=qE+q(v×B)

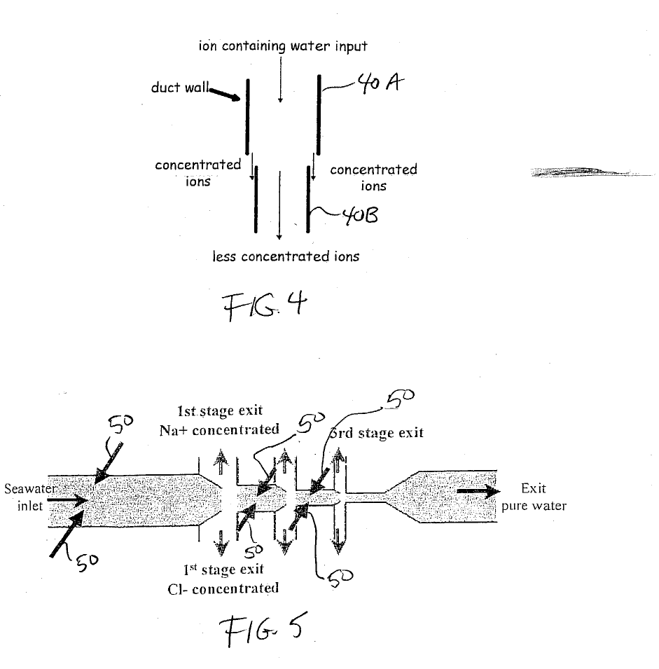

In this equation, qE is the electric force component and q(v×B) is the magnetic force component. The electric force is straightforward, being in the direction of the electric field if the charge q is positive, but the direction of the magnetic art of the force is given by the right-hand rule. The electric and magnetic forces are schematically illustrated below in FIGS. 3A and 3B, respectively.

The magnetic field (Lorentz force) component separate ions in a fluid; however, in the absence of electronic or ionic current flow in the vertical direction, a compensating Hall voltage develops. The Hall voltage is the basis of magnetohydrodynamics (MHD), the study of the motions of electrically conducting fluids and the interactions with magnetic fields.

Before discussing MHD, it is illustrative to describe the workings of a generator. The electrons in the dynamic generator's armature wire are forced to travel in one direction under the influence of a magnetic field. An electrical conductor moving through a magnetic field will dynamically create electricity. As is well known, an electromotive current is created in a wire that traverses through magnetic lines of force. A concentration of electrons along the length of the wire creates a voltage difference between the ends of the wire. Dynamic generators convert the kinetic energy of the moving armature wire into electrical energy. The spinning wire is used to produce electrical power by attaching a shaft to the armature and driving it with a turbine.

Conventional MHD systems use high velocity, electrically conducting fluids, chiefly plasmas or liquid metals, to produce electrical power. These systems are described as direct energy conversion because the rotating generator mechanisms discussed above are replaced with the flowing, electrically conductive fluid. In the channel, the charge carriers are deflected via the Lorentz force by a magnetic field applied perpendicular to the fluid flow. The charge carriers move through the fluid and are deflected to one of the electrodes that carries the electrical current to the load. The advantage of MHD systems over conventional dynamic generators is that the MHD systems have no moving parts except for the flowing charge carriers.

LISA Operation

The basic features of the Lorentz force, Hall effect, and MHD described above lead to the basic use of LISA to separate charged ions from a water stream for desalination or decontamination of seawater, hard water, brackish water, radioactive water polluted water, etc. In general, LISA removes any ionic species from any fluidic source.

This can involve using the Lorentz force to separate ions from a solution stream, discharging the Hall voltage via fluid-flow dynamics, or by connecting the sidewalls to an electrical load, or by electrostatic attraction or oppositely charged ions, harvesting energy using MHD and/or exploiting the discharged ionic currents to power ancillary devices in a scalable, low-energy system.

According to exemplary embodiments, a magnetic field generated by a permanent, electric, and/or superconducting magnet is used to generate a Lorentz force on the positive and negative ions in the fluid to be treated. For the sake of convenience, water is used as the illustrative example; however, in principle, any fluidic medium can be used. The Lorentz force separates the positive ions from the negative ions. The water flows through a ductlike construct, and, with the Reynolds number less than 2000, the flow will be laminar in nature.

The mobilities of ions in water are typically quite low, e.g., approximately 5×10⁻⁸m²V⁻¹s⁻¹. Therefore, if the Lorentz force drives the ions in the ±z direction, the heights of the ducts will likely be limited to relatively small (centimeter or millimeter) size regimes to reduce the time required to separate the slow-moving ions.

While the ion-containing water is flowing through the ducts, the separation of the ionic species creates a Hall voltage. As this develops, it begins to counteract the Lorentz force.

Under steady-state conditions, the force exhibited by the Hall effect is equal to the Lorentz force, and further ion separation ceases. Steady-state is the condition at which conventional MHD is maximized.

To obtain further ionic separation in the water stream, the Hall field should be disturbed periodically before steady-state conditions prevail. In essence, this process is akin to discharging the water “capacitor” of the more highly concentrated ions near the periphery of the duct. Several possible configurations may be used to disturb the charged boundary layer near the duct surfaces, as discussed below.

General Design Considerations

According to exemplary embodiments, flow in the channels should generally be laminar; turbulence would dominate over separation.

Since the drift mobilities and drift velocities, v_{d}˜μ(v×B), of ions in water are relatively low, the total length of the duct the water traverses can be long, and the width of the channel in the direction of the separation should be less 1 cm to minimize duct length.

To further reduce the required length of the duct, the use of a serpentine or spiral configuration for reducing the device's “real estate” is suggested. The serpentine configuration, however, involves many 180 degree turns and so is less efficient.

Pseudo-Virtual Impactor

According to a first embodiment, the Hall voltage may be disrupted using a pseudo-virtual impactor. Traditionally, a virtual impactor is a device used to separate particles by size into two airstreams. It is similar to a conventional impactor, but the impaction surface is replaced with a virtual space of stagnant or slow-moving air. Large particles are captured in a collection probe rather than impacted onto a surface. According to an exemplary embodiment, a pseudo-virtual impactor may be employed to separate more highly concentrated ions in a flow of water near the periphery of the duct from less concentrated ions near the center of the duct. The Lorentz force causes the ions to be more highly concentrated near the duct periphery. The duct walls then can be fabricated of materials that do not shield the magnetic field, but they should be conductive if energy is to be recovered via MHD. The properties of the duct walls are discussed further below.

FIG. 4 shows a schematic diagram of an exemplary pseudo-virtual impactor that includes concentric ducts comprised of different geometries. The inlet duct 40A has a wider opening than the outlet duct 40B. The two concentric ducts 40A and 40B are displaced from each other by a relatively small distance, depending on water velocity (momentum) and relative size (duct length and height). The water may pass through accelerating nozzle and be directed toward a collection tank. At this point, a portion of the flow is diverted away from the collection duct, at which place separation occurs. Water with a higher concentration of ions flow with the streamlines near the periphery and will be carried away to a reject stream. This reject stream may be returned to the original water source, e.g., back to the originating ocean, or to a reject reservoir (the case for radioactive or otherwise contaminated solutions). Alternatively, the reject stream may be recycled into earlier LISA stages or used for energy-recovery processes, as described in further detail below. The water flow near the center of the duct, with a lower concentration of ions, also largely follows its original flow-lines and continue moving axially in its forward path down the collection tank. The separation efficiency curve is determined in part by the water flow velocity, the magnetic field strength, the physical dimensions of the duct, the separation between the concentric ducts, and the duct nozzle geometries.

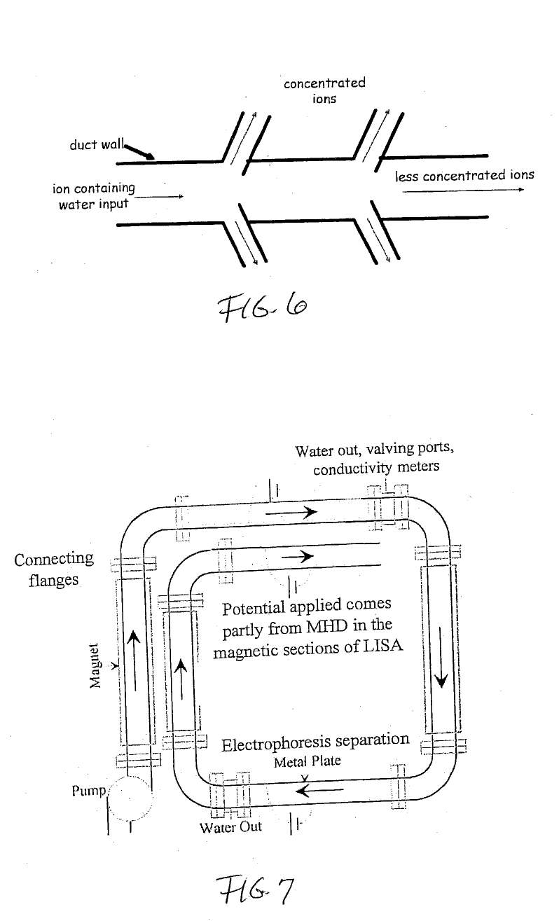

Besides a pseudo-virtual impactor, it may be necessary to incorporate multiple stages as shown in FIG. 5 (the arrows 50 indicate the magnetic field direction, perpendicular to the plane of the figure). The three-stage pseudo-virtual impactor separates the outer flow from the inner flow, or the concentrated saltwater from the dilute saltwater, respectively, as one example. The concept of placing several pseudo-virtual impactors in series is functionally similar to fractional distillation. At each stage, the water becomes more deionized and/or purified. This occurs because once the higher-concentration solution is removed from the periphery, the compensating Hall voltage is reduced and the magnetic Lorentz force dominates the process to continue the separation of the positive and negative ions in the water stream for the next stage. The one disadvantage to this scheme is that the process rejects water at every pseudo-virtual impactor stage, thus requiring consideration of water recovery, an issue yet to be resolved. If the water recovery fraction should prove too low, then a hybrid approach (e.g., LISA followed by RO) may prove to be the optimal configuration, as discussed below. Similarly, the exit stream may be recycled into earlier LISA stages as further discussed below.

Geometrically Defined Holes

According to a second embodiment, the Hall voltage may be disturbed and the water capacitor discharged by defined geometric “holes” in the duct to separate the more highly concentrated ions near the duct periphery from the less concentrated ions near the duct center. This concept is similar to the pseudo-virtual impactor. As is shown in FIG. 6, the water flow near the periphery impacts the trailing edge of the designed hole and exits the duct to the reject reservoir via impaction. The fluid flowing near the center of the duct is not largely disturbed and continues to travel down the duct. Once the more concentrated solution is removed from the periphery, the compensating Hall voltage will be reduced and the magnetic Lorentz force will dominate the process to continue to separate the positive and negative ions in the water stream.

Electrophoresis

According to a third embodiment, the Hall voltage is distributed, the water capacitor of ionic charges is discharged, and the charge carriers are further separated by using electrophoresis in combination with the Lorentz force. Because the Lorentz force can be too small depending on water velocity and/or magnetic field strength, the length of the channel required for separation can be very large and impractical in the first two embodiments described above for pseudo-virtual impactor and geometrically defined holes.

As one example, for desalting a saline solution flowing at 0.25 m/s, calculations indicate that a length of 475 m would be required to move the ions 1 cm perpendicular to the flow under a 1 T magnetic field at zero Hall voltage. Even if it includes a number of parallel channels, such a unit would be relatively big and have a low output. Methods by which to increase output generally include increasing the number of flow channels, decreasing the distance the ions must travel, increasing the travel time of the ions, and increasing the flow velocity. More specifically, these approaches can include decreasing the channel width, increasing the channel length, adding more channels in parallel, increasing the magnetic field strength, and increasing the relative motion between the magnetic field and the ions.

In any case, it may be preferable to use electromagnets instead of permanent magnets, because iron-core electromagnets can produce field strengths of 3-4 T (or even higher with special high-permeability magnetic steels) compared to the ˜1 T of permanent magnets.

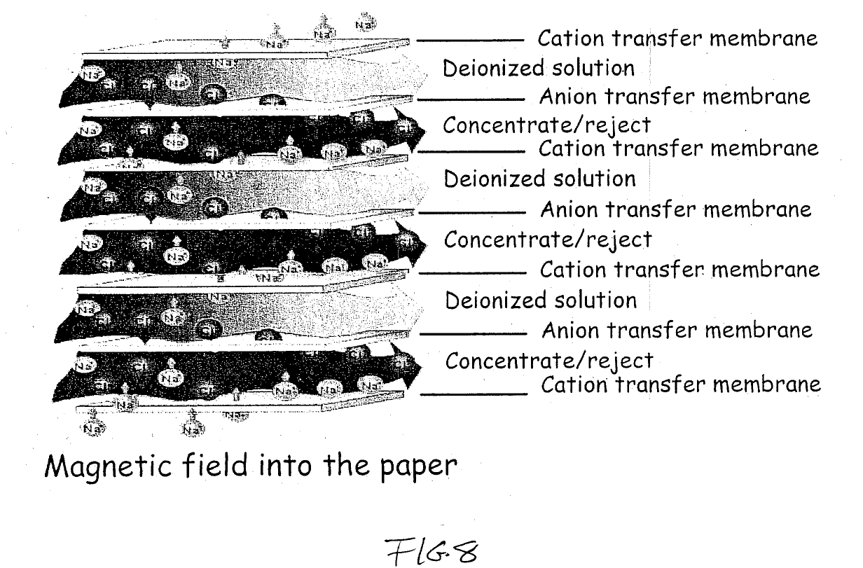

Besides engineering the geometry of the flow ducts and increasing the magnetic field strength, another proposed method by which to reduce the length of separation is to use the Lorentz-force separation in conjunction with a separate electrophoresis section. Electrophoretic separation is achieved by applying an external voltage to the periphery of the duct. The magnetohydrodynamic (Hall) voltage created by the Lorentz force can be used to partially supply the potential necessary to perform electrophoresis, thereby increasing overall system efficiency. This concept can be actualized by simply connecting wires from the Lorentz separation section as shown in FIG. 7 to supply the potential to the electrophoresis section of the LISA. A more sophisticated energy-recovery scheme may be used to exploit the Hall voltage, as described below with regard to energy harvesting.

The energy efficiency of the device depends upon the particulars of the MHD process. The potential created by MHD and transferred to the electrophoretic capacitor will not be sufficient to further separate the ions due to the principle of conservation of charge. Therefore, an external bias should be applied to further the ion-separation process. Notably, as illustrated in FIG. 7, the electrophoresis stage is used in a separate channel. The external bias is not being used to absorb ions, as is the case for flow-through capacitors and/or capacitive deionization apparatuses; instead, it is merely used to further separate the ionic species.

The following is a sample calculation of the process:

Assumptions:

Channel width: w=1.0 cm

Channel height: h=0.5 cm

Channel aspect ratio: a=2

Hydraulic diameter: Dh=0.67 cm

Maximum Reynolds number: R=2000

Viscosity: p=1000 mPa.s

Density: p=1000 kgim3

Maximum velocity (scalar): v_{c}−Rη/2pDh=0.5 mfs.

Definitions:

Drift velocity (scalar, vector): v_{d}, v_{d}

Average water velocity (scalar, vector): u, u

Electrophoretic voltage (scalar, vector): Vₓ, Vₓ

Time required for half-width separation: Δt=(2v_{d})

Total length required for half-width separation: L=uΔΔt

Drift velocity (vector) due to Lorentz force: v_{dL}=μ(u×B)

Drift velocity (vector) due to electrophoretic force: v_{dE}=μ((Vₓ/h)

It is clear from this analysis that μ((Vₓ/h)>μ(u×B).

Magnetodialysis

According to a fourth embodiment, to disturb the Hall voltage, to discharge the water capacitor of ionic charges, and to further separate e charge carriers is to use a LISA-type process that can be considered “magnetodialysis,” which process is illustrated in FIG. 8.

In an electrodialysis (ED) membrane-based separation process, ions are driven through an ion-selective membrane under the influence of an electric field. The key to the ED process is a semipermeable barrier that allows passage of either positively charged ions (cations) or negatively charged ions (anions) while excluding the passage of ions of the opposite charge. These semipermeable barriers are commonly known as ion-exchange, ion-selective, or electrodialysis membranes.

For the case shown in FIG. 8, a magnetic field is used to separate the ions via the Lorentz force rather than an electric field. A magnetic field is required to separate ions in the channels, but it does not precipitate them. Therefore, the process can be termed magnetodialysis (MD). The compensating Hall voltage is discharged through the concentrate/reject ports, i.e., through the walls. By proper design of the geometry of the system, an external magnetic field separates the anions from the cations. Furthermore, the electrostatic attraction between the cations (e.g., Na⁺ at the cation transfer membrane and the anions (e.g., Cl⁻) at the anion transfer membrane forces these ions to transport across their respective membrane walls and to concentrate in the reject/concentrate flow. The electrostatic attraction of the anions and cations near their respective ion-selective membranes provides the potential to drive or transport the ions and cations to blend in the concentrate stream, thereby “discharging” the compensating Hall voltage.

Chambers, e.g., with flow parallel to the magnetic lines of flux, adjacent to the channels, collect anions from a channel on one side and cations from another channel on the other side, and contain a sweep fluid to remove the ions. Alternately, a porous partition on one side can allow fluid enriched in one ion to enter the chamber where electrostatic attraction pulls the other type ions through a ion-selective membrane. Either procedure avoids ion build-up on the channel walls and allows the separation to continue.

The electrostatic attraction is similar in spirit to the electrophoresis voltage used in FIG. 7.

One MD arrangement is opposing, laminated magnet poles, with brine flowing in channels between the poles. Separators (e.g., ion-selective membranes) on both sides of the channels would allow ions (e.g., Cl⁻ ions to the left side and Na⁺ ions to the right) to exit into recombination chambers (concentrating a sweep solution) between the teeth. The ions remix in the recombination chamber and exit, e.g., between the laminations. Controlling the pressure difference across the separator can control flow through the separator.

Flows are preferably laminar on the input side so the size of the flow channels should probably be small, e.g., 01 cm. The magnetic poles may have a circular arrangement (e.g., a circular north pole as an outer ring, with the south-pole inside), such that end channels with recombination chambers only on one side are avoided.

The separators might have a miniature “ricer” shape such that inertia helps scoop the heavier ions out of the input channels.

In one method of magnetic de-ionization, at least one of the faces of the wall is an ion-selective membrane. In electrodialysis, membranes that have been used allow selective passage of certain ions. In the past, ion-selective materials have been widely used to adsorb either anions or cations out of a liquid, with the ion being bonded, e.g., to a surface site on a zeolite material. A home water softener uses anions loosely bonded on such sites, and the exchange of anions to “soften” water (e.g., a calcium ion replaces a sodium ion on the surface). We have discovered that with pressure and/or magnetic force applied, an ion-selective membrane can allow the passage of either anions or cations from a primary fluid, through an ion-sensitive membrane, to a secondary fluid, with little or no passage of either fluid. The loosely bonded ions are on the surface of pores, and the pores pass through the material. With enough force applied, a sodium ion from the primary fluid pushes on, and replaces a sodium ion loosely bonded on the material surface, which ion in turn replaces an adjacent ion. This continues until an ion on the far side of the membrane passes into the secondary fluid. In effect, “lines” of ions continue to shift and, in that type of ion, the primary fluid is depleted and the secondary fluid is enriched. The primary fluid can be depleted and the secondary fluid can be enriched in the opposite type of ion by an opposite type of ion-selective membrane (e.g., removing chlorine) at the opposite channel wall of the primary fluid.

The ion-selective membranes provide a more effective way of de-ionizing. When magnetic or electrostatic separation is used, a distribution of ions is produced where, at one wall, anions are concentrated and cations are partially depleted (vice-versa at the opposite wall). Removing fluid from adjacent the walls is productive in that it removes ions of higher concentration than the input fluid, but counter-productive in that fluid is being removed which is partially depleted in other ions. If both concentrations and both depletions were all of an equal number of atoms, no de-ionization of the primary fluid would result. Thus some preferred embodiments use a pair of ion-selective membranes (one cation and one anion), and a sweep fluid (e.g., the same type of fluid as the input fluid or recycle from a later stage). Although somewhat less effective in ion removal rate, the use of one ion-selective member and one porous partition (using fluid passing through the porous partition as the secondary fluid) has the advantage of expediting the removal ions which do not easily pass through such membranes. Sodium and calcium ions pass much better than magnesium ions through some anion membranes. Using e.g., a cation selective membrane and porous partition combination, allows removal of magnesium ions as well. Large ions, e.g. carbonate ions, do not pass well through some cation selective membranes, but are removable by an anion-selective membrane and porous membrane combination.

Thus, a pair of ion-selective membranes might be used in one portion of a system, a cation selective membrane and porous partition combination in another portion, and anion-selective membrane and porous membrane combination in yet other portion.

According to exemplary embodiments, a magnetic field is used to cause anions and cations to separate.

A pressure differential between the channels and inside the hollow walls and the force from the relative motion between the ions and the magnetic field causing of the ions to pass into the walls. In most embodiments, the walls are thinner than the channels are wide and the Hall voltage is at least largely offset by the electrostatic a cation from oppositely charged ions on the opposite side of the wall. In many embodiments, the electrostatic attraction is large enough to assist in moving the ions into the walls.

Generally, the fluid in the channels flows at a velocity such that the flow is laminar, and turbulent flow is avoided. Flow within the hollow walls can be either laminar or turbulent.

According to one embodiment, there are two end channels and at least seven interior channels. At least partially deionized fluid from the interior channels is used as product and fluid from the end channels is recycled.

In an alternate embodiment, channels are assembled into cylinder about an axis with an equal number of channels and walls, such that walls without channels on both sides are avoided.

In some embodiments, ion-selective membranes are used on one side of the walls, and porous partitions are used on the other. In other embodiments, ion-selective membranes are used on both sides of the walls, and a sweep fluid is used within the walls. The sweep fluid may be of the same type of fluid input into the channels. The sweep fluid may be a portion of fluid output from the channels, which may be run as a counterflow sweep.

In some systems, ion-selective membranes are used on both sides of the walls, and a sweep fluid is used within the walls in a first stage. At least one later stage uses ion-selective membranes on one side of the walls and porous partitions on the other.

Porous partitions, e.g., porous membranes or ricer shaped partitions, can be used on both sides of the walls. Alternatively, an ion-selective membrane on at least one side may be used.

According to exemplary embodiments, the fluid containing positive ions and negative ions may be saline water, brackish water, seawater, ion-containing gas, and/or nuclear waste.

In some embodiments, the fluid containing positive ions and negative ions is deionized, and potable water is produced. In other embodiments the fluid containing positive ions and negative ions is partially deionized and further processed by reverse osmosis, and potable water is produced.

In some embodiments, more than one stage of de-ionization is used and the ion-concentrated fluid exiting a later stage is recycled to an earlier stage.

Wall Effects in LISA

One of the many unique features of the LISA process is the affect of the walls of the ducts. In electrostatic ionic separation processes, the ions are attracted to the wall, and they are adsorbed onto the wall (high-surface-area electrode). Once adsorbed, desorbing the ions from the electrode surface is a technical challenge. Similarly, in a magnetically-driven separation process, the ions are magnetically forced to the wall. However, the separated ions are not adsorbed onto the duct walls, but are instead relatively free to pass through the walls if conditions are right.

Depending on the configuration, it may not always be advantageous to have the ions pass though the walls. For one particular case, the ions are separated using the pseudo-virtual impactor and/or geometrically defined holes described above. In any event, the wall is not the ion collection portal. The ions are collected in ancillary concentrated/reject ports. For the LISA process, the wall need not be composed of impermeable materials to adsorb the ions nor to impede their relative motion. The walls of the duct can be formulated as porous membranes on both sides (with relatively large pore sizes to allow ions to pass through, but to provide some flow resistance to the fluidic media), an ion-permeable membrane on one side and a porous membrane on the other, different ion-selective permeable membranes on both sides of the duct, with one side anion-selective and the other cation-selective, or electrode plates to collect the MHD potential. If electrode plates are used, the pseudo-virtual impactor and/or geometrically defined holes would be required to separate the ion-rich fluidic media from the ion-poor media.

If the ions are removed almost as soon as they reach the walls, and their movement is very slow, then the ion distribution across most of the channel will be almost flat and will remain almost flat as the solution becomes more dilute as purification continues; the only major increase in ion density would be at the walls. In that case, the ion-flow-retarding Hall voltage across the channel is lower than the voltage across the wall-the counterions across the wall are closer than those across the channel, so the net electrostatic attraction increases the ion flow. An essential element is forcing the ions to flow from a region of lower concentration within the channel to a region of higher concentration within the wall. The forces tending to make the ions flow into the wall include (1) the action of the magnetic field upon the ions, (2) the net electrostatic attraction from the counterions within the wall, and (3) a somewhat lower pressure within the wall that partially offsets the concentration gradient.

The phenomena above can limit the degree of practical purification achieved per stage. For example, if ions only flow at practical speeds into a fluid with 0.2 molar (M) higher concentration, then the waste stream from a 0.6-M input could be 0.8 M. The waste stream from a 0.4-M input stage could be 0.6 M, or equal to the original input stream. Therefore, the first stage can go from 0.6 M to 0.4 M while the increased-concentration waste stream is discarded. The second stage could go from 0.4 M to 0.2 M while the increased-concentration waste stream is recycled back to the first stage. The third stage could go from 0.2 M to 0.05 M while the increased-concentration waste stream is recycled back to the second stage.

Energy Harvesting

Magnetohydrodynamics

One of the beneficial aspects of the LISA technology is energy recovery using MHD. One of the unique aspects of the LISA technology or removing ions from fluidic media is energy recovery using capacitor charging/discharging schemes. Energy recovery helps make the process more cost-competitive.

During the operation of the LISA, the periphery of the duct will become largely concentrated with ions. At this time, it is necessary to disturb the boundary layer to destroy the compensating Hall voltage as discussed above. Disturbing the boundary layer is equivalent to discharging the water capacitor.

According to an exemplary embodiment, the negative consequences of a compensating Hall voltage may be utilized in a positive manner. The compensating Hall voltage can be used to increase total LISA system efficiency via MHD.

MHD systems use high-velocity electrically conducting fluids in the presence of a magnetic field to produce electrical power. The ions are deflected by a magnetic field applied perpendicular to the flow via the Lorentz force. These charge carriers move through the fluid and are deflected to one of the electrodes that carries the electrical current to the load. The resulting electrical current can be used to increase system efficiency. For instance, this current can be reused to run the pumps moving the fluid (e.g., saline solution) through the ducts.

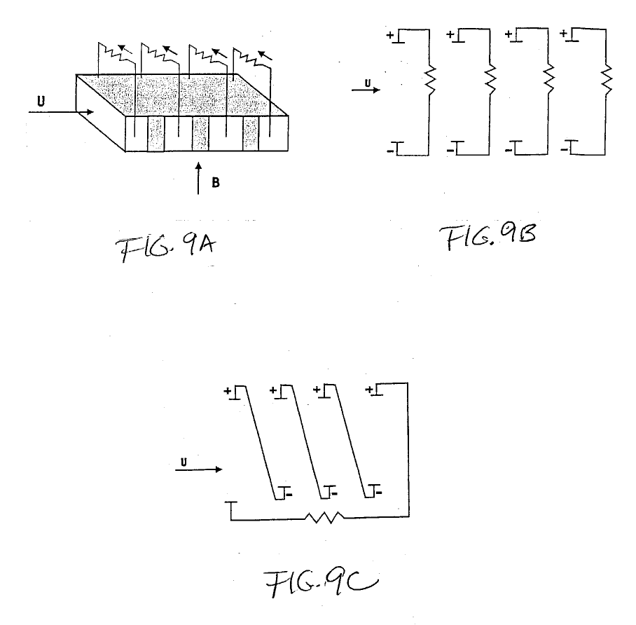

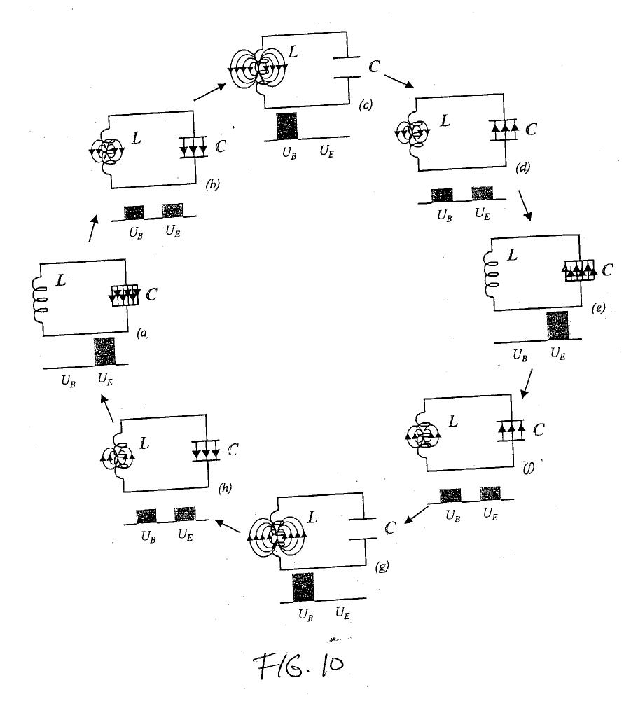

For the LISA system, one process by which to harness this energy is to use a segmented electrode construction as shown in FIGS. 9A-9C. It is possible to exploit MHD and to reduce the Hall voltage at the same time. FIGS. 9A-9C illustrate the case in which the electrode system includes four pairs of electrodes insulated from each other by three insulating barriers; however, any number of electrode pairs separated by an insulating layer can be used. The insulating barriers may be ceramic insulators or nonconducting ion-selective membranes or porous partitions.

FIG. 10A and FIG. 10B show each pair of electrodes connected to a load; FIG. 10C shows the four pairs of electrodes C connected in series to a common load. The common load provides a means by which the Hall voltage can be discharged. As one example, the common load could go back to the pump or control electronics or it could be used to charge the capacitor plates used for electrophoresis.

For energy recovery, the two capacitors (the MHD capacitor and the electrophoresis capacitor) may be connected in parallel with appropriate switches. The following analysis assumes these conditions: (1) both capacitors have the same capacitance; (2) only one of the capacitors is electrically charged and e switch connecting them is open; and (3) the process has zero resistance. Upon closing the switch, the charged capacitor will partially discharge to the other capacitor until their electrical charges equilibrate. The first capacitor discharges approximately 50% of its charge. The benefit to this charge/discharge scheme of using two capacitors in parallel for the LISA process is simple when the MHD capacitor is electrically discharging, it can charge the electrophoresis capacitor. Using appropriate switching rates, the process simply shuttles electronic charge back and forth between the capacitors for partial energy recovery, with the energy recovery being approximately 25% efficient. The rest of the charge required by the capacitor should be supplied by an external source (e.g., battery). Significantly, the proposed device does not shuttle ionic charge, just electric charge.

While the aforementioned process is promising, it can be made still more efficient. One method by which to accomplish this is the use of electromagnetic oscillations. The proposed scheme involves appropriate switching between a capacitor (C) and an inductor (L). In the following analysis, the process is assumed to have zero resistance. Subsequently, the impact of that assumption is examined.

In the energy-recovery LC system, the potential energy of the MHD capacitor, E_{C}=½Cq², where C is the capacitance and q is the electronic charge, will be converted into the kinetic energy of an inductor, E_{L}=½LI², where L is the inductance and I is the current. The MHD capacitor begins fully charged as shown in FIG. 10, panel (a). The charge leaves the capacitor plates and current begins to flow. The loss of charge in the capacitor decreases its potential energy (½Cq²), while the creation of a current causes the kinetic energy of the inductor (½LI²) to increase with time as shown in panel (b). At some time, capacitor will fully discharge, panel (c). At this moment, the potential energy of the capacitor is zero (it has no more charge or electric field), while the kinetic energy of the inductor is maximized (in terms of current and magnetic field).

The current (moving charge) in the inductor will start to transport charge back to the capacitor in the circuit. In the LISA process, the capacitor in question will now be the electrophoretic capacitor. Energy now begins to transport from the inductor (decreasing kinetic energy) to the electrophoretic capacitor (increasing potential energy) as illustrated in panel (d). Eventually, the energy becomes completely transferred from the inductor to the electrophoretic capacitor, panel (e). The process continues in a cyclic fashion; the charged capacitor will begin to discharge, converting its potential energy to kinetic energy of the inductor in panels (f) and (g). The combined capacitor-inductor circuit shuttles energy from a capacitor (electric field energy), to an inductor (magnetic field energy), back to another capacitor, and back to the inductor in a cyclic fashion. In essence, the LC harmonic oscillations shuttle charge with 100% energy recovery.

The process just described is a LC harmonic oscillation that will continue indefinitely under the conditions of zero resistance. However, in reality, the circuit has measurably nonzero resistance. Therefore, sustaining the electromagnetic oscillations requires the periodic supply of external energy to compensate for the Joule-heating losses that arise from resistive leads. The resistance dampens the amplitudes of the oscillation, i.e., the energy going to the capacitors becomes smaller and smaller as it is lost to resistive heating. Nevertheless, in principle the electromagnetic LC oscillation scheme enables significantly greater energy recovery than that achievable by two capacitors in parallel. This concept could make the LISA process a low-energy process.

Ionic Current

Besides MHD energy recovery, it is possible to recover energy from the concentrated/reject ion-rich ports. These reject ports are not only concentrated in ions, but because of the ion-separation process, they are also rich in one type of ion. Therefore, as the fluid flows in these reject ports, it conducts an ionic current. This ionic current may be recovered to further improve the energy efficiency of the LISA process. The cation-rich and anion-rich ionic currents may be connected to an external load (e.g, capacitor plates).

Examinations of the LISA process reveal a number of energy-recovery processes available for exploitation, from the Hall voltage to the ionic current in the reject ports. Furthermore, while these effects can make the LISA process more efficient, they do not violate the first law of thermodynamics.

Preliminary Energetics of LISA

The energetics of the LISA system, in principle, should be quite low for a number of reasons. First, LISA removes the charge-carrier solute from the solution rather than the solvent from the solution. That is, LISA removes minority constituents, not the majority constituent. (Reverse osmosis removes the solvent.)

Second, the energetics of LISA do not violate the enthalpy of solution. Dissolving a solute involves three processes, (1) breaking ionic forces, (2) expanding the solvent cage, and (3) stabilizing the ions. Each of these steps has an associated enthalpy change (ΔH): ΔHₛₒₗᵤₜₑ, always positive; ΔHₛₒₗᵥₑₙₜ, always positive, and ΔH_{mixing}, always negative. The heat of solution (ΔHₛₒₗᵤₜᵢₒₙ) is the sum of these three terms. LISA does not involve breaking ionic forces, stabilizing ions, nor expanding the solvent cage. It is a process that simply separates the ions already in the solution into regions of relatively higher and lower concentrations, but never takes them out of solution. Therefore, the process requires relatively low energy.

Third, if permanent magnets (which can provide −1 T of magnetic flux) are used, the embodiments of LISA use a minimal amount of external energy. The sources of external energy include a pump to move the water and perhaps an external voltage supply for electrophoresis. The pumps probably should provide only 50-100 psi (340-690 kPa) of pressure, which is very small in comparison to that used in RO systems, 800-1000 psi (5.5-6.9 MPa). This being the case, it is reasonable to assume that some energy costs and usage are directly proportional to applied pressure (LISA=50-100 psi, RO=800-1000 psi); therefore, such energy costs can be reduced by factors of approximately 10× over RO. If superconducting magnets are used, the operational costs will increase somewhat because liquid nitrogen or helium would have be supplied to the magnets periodically. Efficiency would also improve, so the type of magnet chosen should be subjected to a cost-benefit analysis.

LISA has built-in energy recovery exploiting the MHD process and the charge-unbalanced ionic current discussed earlier. Determining the amount of energy recovered will require experimentation and testing. The energy recovered may be used for electrophoresis and/or water pumping.

LISA Attributes

A LISA water purification system according to exemplary embodiments has many attributes. For example, it requires little or no water pretreatment. In principle, it has very low energy consumption and incorporates energy recovery. It does not require the use of harmful chemicals. It has minor logistics issues for deionization operate on. Its total costs (capital plus operating) are estimated to be highly cost-effective per unit of flow, and it is expected to be affordable to any person of any economic or social background. Since the water pressures used can be relatively low, 50-1 0 psi (340-690 kPa), low-cost plumbing and seals can be used. This is not the case with R systems. It is a simple design and simple to operate. It can remove any charged species from any fluid medium. In principle, it can be constructed without membranes subject to fouling?. Its design can be applied on many scales. It can purify water of any charged or chargeable contaminant, including both biological (viruses, bacteria), and chemical (radioactive nuclides) species.

The LISA process is a fundamentally orthogonal and scalable de-ionization technology (e.g., water desalination technology) that has many advantages in comparison to state-of-the-art ion separation technologies such as reverse osmosis, distillation, and variants thereof. For example, LISA can be at least ten times more energy-efficient. LISA requires less maintenance (virtually no fouling), can have greater water throughput, and can be more cost-effective. Also, LISA can be used with any charged ionic species and in any fluid medium (gas, plasma, solutions, etc.).

Integration of LISA and RO Technologies

According to yet another embodiment, the LISA and RO technologies may be combined in a hybrid approach for purification of aqueous solutions. For example, the LISA may be used upstream of an RO unit. This would significantly reduce the duty requirements on both systems in handling copious amounts of total dissolved solids; therefore it could reduce the total energy consumption of the integrated hybrid system. Likewise, because LISA is better able to handle radioactive elements and heavy metals, with the additional benefit of being able to dispose of them in a safer manner during a concentrated discharge process, it can improve the effectiveness of a downstream RO unit. An upstream LISA could also be used to significantly reduce the salt concentration in saltwater feeding into an RO unit, in which case the water flux through the RO membranes will increase substantially because the concentration polarization of salt near the membrane surface is reduced, leading to overall more efficient system. In addition to a LISA device feeding into an RO system, a LISA device may also be used to feed into a forward or direct osmosis (FO) configuration.

### EXAMPLES

During the first stage of magnetic purification, the use of a pair of ion selective membranes (one positive selecting and one negative selecting) on the sides of a hollow wall and a sweep stream within the wall can give a high ion extraction rate without causing a high retarding Hall voltage. The combination of magnetic field induced molarity buildup at wall and mutual attraction of ions on opposite faces provides force that could transfer ions through the pair of ion selective membranes into the sweep fluid that has, e.g., a 0.15 to 0.20 higher molarity than the process fluid. However, an additional 0.05 to 0.1 rise is available from the 100 to 200 psi higher pressure of the process fluid compared to the waste stream, and thus the ions can be transferred into a higher molarity sweep stream, with, .g., a total of 0.20 to 0.30 molarity rise, or even 0.40 with 400 psi. The molarity rise of waste above the process fluid is also the amount the process fluid can be reduced in that stage, thus the first stage can reduce the molarity of the process stream from, e.g., the 0.4 of brackish water t a.2 or 0.1 stream. Similarly, the 0.6 of seawater can be reduced to a 0.4 or 0.3 or even a 0.2 stream.

Further stages of magnetic purification may use one ion selective membrane and a porous partition as sides of the wall. Ion buildup on opposite sides wall from the combination of ion movement due to magnetic forces and mutual attraction of ions on opposite faces provide ion buildup to give a recycle stream of at least a 0.15 to 0.2 higher molarity than the average process fluid in the waste fluid stream. Fluid is transferred tough a porous partition on one side while combination of molarity buildup at wall, and mutual attraction of ions on opposite side of ion selective membrane, provide force to transfer ions through the ion selective membrane.

As an alternative, part of output may be used as recycle in a counterflow flush in the further stages, and the recycle may be pumped back into the inlet, with sets of opposite ion selective membranes used throughout (a flush of saline of the same salinity as input saline, would still be used for stage I). If flowing in a direction opposite to the main flow, ions in recycle will tend to move in a direction to pull ions through the membranes, but flow may be turbulent in thee recycle stream.

The following examples illustrate various stages.

### Example 1

Stage I Saline Sweep Waste Stream

input pressure 200 psi,

input molarity; 0.4 molar (brackish water)

waste molarity; up to ˜0.1 above that of input saline

process fluid to waste, molarity rise: low at entrance. 0.3 max

product stream molarity; goes from 0.4 to 0.1

output molarity; 0.1 molar

uses 2 ion selective membranes

Process fluid volume out of Stage I is only slightly less than the Stage I and sweep volume input, and sweep volume may be between 5 and 20 times the product volume.

Stage II, Reverse Osmosis

booster pump 0 400 psi

input molarity; 0.1 molar input

waste molarity; about 0.2

product stream; goes from 0.1 molarity to <500 ppm

output; <500 ppm

uses RO membranes

product volume=½ of RO input volume

In Example 1, 2 ion selective membranes are used. A saline sweep of same salinity as the input saline is used, and a sweep flow of between 5 and 20 times the product flow. Product fluid volume out is about 50% of the volume in Stage I, thus the first stage needs to have 2 times the capacity of product output.

### Example 2

Stage I, with Saline Sweep Waste Stream

input molarity; 0.4 molar input

waste molarity; barely above that of input saline

molarity rise: initially ˜O goes up to 0.2 rise at stage end

product stream molarity; goes from 0.4 to 0.3

output molarity; 0.3 molar output

uses, e.g., 2 ion selective membranes

Stage II, Exhaust Stream Recycled to Stage I

input molarity; 0.3 molar input

recycle molarity; goes from 0.45 to 0.35 (average 0.4)

molarity rise: 0.15 rise

product stream molarity; goes from 0.3 to 0.2

output molarity; 0.2 molar output

uses, e.g., 1 ion selective membrane and one porous partition

recycle=50% of its input volume

Stage III, Exhaust Stream Recycled to Stage II

input molarity; 0.2 molar input

recycle molarity; goes from 0.35 to 0.25 (average 0.3)

molarity rise: 0.15 rise

product stream molarity; goes from 0.2 to 0.1

output molarity; 0.1 molar output

uses, e.g., 1 ion selective membrane and one porous partition

recycle=50% of its input volume

Stage IV, Exhaust Stream Recycled to Stage III

input molarity; 0.1 molar input

recycle molarity; about 0.25 to ˜0.15 (average ˜0.2)

molarity rise: about 0.15

product stream; goes from 0.1 molarity to <500 ppm

output; <500 ppm [−0.009 molar]

uses, e.g., 1 ion selective membrane and one porous partition

recycle=50% of its input volume

In Example 2, the first stage needs to have a volume capacity of 8 times the product volume. Example 2 has almost the same product output as new saline in, and thus avoids doing any extra pretreatment to the fluid. Example 2 uses more relaxed requirements for molarity rise than example 1, and thus reduces needed residence time in the field and further reduces Hall voltage effects. Note also that the ion drift velocity near the porous partition can be the same order of magnitude as the velocity of the flow through the partition, but velocity of flow is much smaller near the opposite wall.

### Example 3

Stage I, Saline Sweep Waste

stream input pressure 220 psi

input molarity; 0.4 molar input

waste molarity; barely above that of input saline

molarity rise: −0 goes up to 0.1 rise at stage end

product stream molarity; goes from 0.4 to 0.3

output molarity; 0.3 molar output

uses, e.g., 2 ion selective membranes

Stage II, Exhaust Stream Recycled to Stage I

input molarity; 0.3 molar input

recycle molarity; goes from 0.45 to 0.35 (average 0.4)

molarity rise: 0.15 rise

product stream molarity; goes from 0.3 to 0.2

output molarity; 0.2 molar output

uses, e.g., 1 ion selective membrane and one porous partition

Stage III, Exhaust Stream Recycled to Stage II

input molarity; 0.2 molar input

recycle molarity; goes from 0.35 to 0.25 (average 0.3)

molarity rise: 0.15 rise

product stream molarity; goes from 0.2 to 0.1

output molarity; 0.1 molar output

uses, e.g., I ion selective membrane and one porous partition

Stage IV, Exhaust Stream Recycled to Stage III

input molarity; 0.1 molar input

recycle molarity; about 0.25 to ˜.15 (average 0.2)

molarity rise: about 0.15

product stream molarity; goes from 0.1 to 0.05

output molarity; 0.05 molar output

uses, e.g., 1 ion selective membrane and one porous partition

Stage V, Reverse Osmosis at Pressure of 200 psi

input molarity; 0.05 molar input

waste molarity; about 0.1

product stream; goes from 0.05 molarity to <500 ppm

output; <500 ppm

uses RO membranes

product volume ˜ of RO input volume

Example 3 is similar to example 2, but uses a low pressure RO polishing at the end.

### Example 4

Stage I, Seawater Input and Sweep

input pressure 400 psi,

input molarity; 0.6 molar (seawater)

waste molarity; up to ˜0.1 above that of input saline

molarity rise: up to 0.4 rise

product stream molarity; goes from 0.6 to 0.2

output molarity; 0.2 molar

uses 2 ion selective membranes

process fluid volume out of Stage I is only slightly less than the Stage I process volume input, and sweep volume may be between 5 and 20 times the product volume

Stage II, Reverse Osmosis

booster pump to 500 psi

input molarity; 0.2 molar input

waste molarity; about 0.25

product stream; goes from 0.2 molarity to <500 ppm

output; <500 ppm

uses RO membranes

product volume=⅕ of RO input volume, −⅕ of input volume

Example 4 is a higher pressure system (although still much lower than a conventional RO system). It is also for seawater, rather than brackish water.

### Example 5

Stage I, Saline Sweep Waste Stream

input molarity; 0.6 molar seawater input

waste molarity; barely above that of input seawater

molarity rise: ˜O goes up to 0.4 rise at stage end

product stream molarity; goes from 0.6 to 0.4

output molarity; 0.4 molar output

uses, e.g., 2 ion selective membranes

Stage II, counterflow stream recycled to Stage I

input molarity; 0.4 molar input

recycle molarity; goes from 0.1 at exit to 0.6 (recycle=0.6)

molarity rise: 0.2 rise

product stream molarity; goes from 0.4 to 0.1

output molarity; 0.1 molar output

uses, e.g., 2 ion selective membranes

recycle volume=50% of volume (stages I and II have about the same volume)

Stage III, Reverse Osmosis at Pressure of 30 psi

input molarity; 0.1 molar input

waste molarity; about 0.15

product stream; goes from 0.1 molarity to <500 ppm

output; <500 ppm

uses RO membranes

product volume=Y2 of RO input volume

Example 5 has a seawater input, has counterflow recycling, and uses a moderate-pressure RO polishing at the end.

Effectively getting the ions into the exit walls avoids any major increase in ion concentration in the channel away from the walls. This assures that the major electrostatic force on the ions at the walls will be from ions on the other side of the walls, and not from ions on the other side of the channel. Note that ions have a very short distance to travel to give a 0.1 molar rise near the wall and that separation at the wall can begin relatively quickly.

Note that if a stage removes half the water, e.g. ½ out of one wall, or even ¼^{th} out of each wall, the sideways water flow can be the same order of magnitude as the sideways ion flow (drift). Note that this helps extract ions nearer their exit side, but slow or even stop drift of ions from the side opposite that ion's exit side. This effect tends to move ions near their exit wall out, but can tend to level the ion distribution somewhat. Thus it gives a net increase the extraction rate at the beginning and through most of the purification process, but also may slow the extraction rate later in the purification process.

Note also that with the ion selective membrane on one side of the wall and a graded porosity partition on the other (with lower porosity nearer the waste exit) opposite ions would be separated only by a single membrane, rather than the width of the wall.

According to exemplary embodiments, a method and apparatus have been developed for deionizing any fluid using Lorentz forces. Basically, the Lorentz forces are used to separate the charged species from any fluid. Electrophoresis and electrostatic attraction amongst oppositely charged ions may also be used, along with the Lorentz forces, to separate the charged species from the fluid. Regions of high ion concentration may be separated from those of lower ion concentration using a psuedo-virtual impactor, geometrically defined holes in the duct, porous partitions, ion-selective membranes and/or variations thereof. For energy recovery in the LISA process, magnetohydrodynamics may be used, the charge may be shuttled between capacitive and inductive elements and/or the discharged ionic current that is comprised of mostly one ionic species may be used.

It should be understood that the foregoing description and accompanying drawings are by example only and are not intended to limit the present invention in any way. A variety of modifications are envisioned that do not depart from the scope and spirit of the invention.

What is claimed is:

1. A method for purifying fluid, comprising:
separating a charged species from the fluid, wherein the step of separating creates a voltage that counteracts separation of the charged species from the fluid; and
discharging the voltage.

2. The method of claim 1, wherein the step of discharging the voltage is performed periodically.

3. The method of claim 1, wherein the voltage created is a Hall voltage.

4. The method of claim 1, wherein the steps are performed on the fluid as it flows through ducts having walls, and the Lorentz force causes the ions to be most concentrated at the walls of the ducts.

5. The method of claim 4, wherein the step of discharging the voltage is performed by rejecting a portion of the fluid at the walls of the ducts.

6. The method of claim 5, wherein the step of rejecting is performed by a pseudo-virtual impactor including concentric ducts having different geometries that separate a more ion concentrated portion of the fluid from a remainder of the fluid.

7. The method of claim 6, wherein the step of rejecting is performed in several stages, and at each stage the fluid becomes more purified.

8. The method of claim 5, wherein the step of rejecting is performed by holes in the walls of the ducts separating highly concentrated ions near the duct walls from a remainder of the fluid.

9. The method of claim 4, wherein the step of discharging the voltage includes applying an external voltage to the walls of the ducts for electrophoretic separation.

10. The method of claim 4, wherein the step of discharging the voltage includes using an electrostatic attraction of the negatively and positively charged ions.

11. The method of claim 5, wherein for rejecting a portion of the fluid, the walls of the ducts are formed from a porous member having pores on both sides large enough to allow ions to pass through but small enough to provide some flow resistance to the fluid.

12. The method of claim 5, wherein for rejecting a portion of the fluid, the walls of the ducts are formed from a material having an ion-permeable membrane on one side and a porous membrane on the other side.

13. The method of claim 5, wherein for rejecting a portion of the fluid, the walls of the ducts are formed from material having different ion-selective permeable membranes of both sides, with one side anion-selective and the other cation-selective.

14. The method of claim 1, further comprising harvesting energy from the discharged voltage.

15. The method of claim 14, wherein for harvesting energy from the discharged voltage, the walls of the ducts are formed from electrode plates collecting magnetohydrodynamics potential.

16. The method of claim 5, further comprising harvesting energy from the discharged voltage by recovering ionic current from reject ports.

17. The method of claim 14, further comprising harvesting energy from the discharged voltage using electromagnetic oscillations.

18. The method of claim 1, further comprising using reverse osmosis for purifying the fluid.

19. A method for at least partially deionizing a fluid, the method comprising:
inputting fluid containing positive ions and negative ions into a device including at least three channels with a first hollow separating wall between the first channel and the second channel and a second hollow separating wall between the second channel and the third channel;
using the fluid containing positive and negative ions and a magnetic field to cause positive ions in the first channel to move toward the first wall and to cause positive ions in the second channel to move toward the second wall and to cause negative ions in the second channel to move toward the first wall and to cause negative ions in the third channel to move toward the second wall, wherein positive ions from the first channel are concentrated adjacent a positive face of the first wall and negative ions from the second channel are concentrated adjacent a negative face of the first wall, and wherein positive ions from the second channel are concentrated adjacent a positive face of the second wall and negative ions from the third channel are concentrated adjacent a negative face of the second wall;
forcing negative ions from the second channel to pass through the first wall negative face into the first hollow wall and forcing positive ions from the first channel to pass through the first wall positive face into the first hollow wall, wherein the positive and negative ions mix in the first hollow wall and form ion-concentrated fluid;
forcing negative ions from the third channel to pass through the second wall negative face into the second hollow wall and forcing positive ions from the second channel to pass through the second wall positive face into the second hollow wall, wherein the positive and negative ions mix in the second hollow wall and form ion-concentrated fluid; wherein force that forces ions through the first wall faces is supplied by movement of ions relative to a magnetic field and at least one of a channel pressure that is higher than pressure in the first hollow wall and electrostatic attraction between the positive ions adjacent a positive face of the first wall and negative ions adjacent a negative force of the first wall, and wherein force that forces ions through the second wall faces is supplied by movement of ions relative to a magnetic field and at least one of a channel pressure that is higher than pressure in the second hollow wall and electrostatic attraction between the positive ions adjacent a positive face of the second wall and negative ions adjacent a negative face of the second wall;
allowing ion-concentrated fluid to exit the hollow walls; and
retaining at least partially deionized fluid in the channels.

20. A method for at least partially removing both anions and cations from a fluid, comprising:
inputting fluid containing positive ions and negative ions into a device including at least three channels with a first hollow separating wall between the first channel and the second channel, and a second hollow separating wall between the second channel and the third channel;
using said fluid containing positive and negative ions and at least one of a magnetic and a electrostatic field cause anions and cations to separate, such that positive ions in the first channel move toward the first wall and positive ions in the second channel move toward the second wall, and negative ions in the second channel move toward the first wall an negative ions in the third channel move toward the second wall, wherein positive ions from the first channel are concentrated adjacent a positive face of the first wall and negative ions from the second channel are concentrated adjacent a negative face of the first wall, and wherein positive ions from the second channel are concentrated adjacent a positive face of the second wall and negative ions from the third channel are concentrated adjacent a negative face of the second wall;
forcing negative ions from the second channel to pass through the first wall negative face into the first hollow wall and forcing positive ions from the first channel to pass through the first wall positive face into the first hollow wall, wherein the positive and negative ions mix in the first hollow wall and form ion-concentrated fluid;
forcing negative ions from the third channel to pass through the second wall negative face into the second hollow wall and forcing positive ions from the second channel to pass through the second wall positive face into the second hollow wall, wherein the positive and negative ions mix in the second hollow wall and form ion-concentrated fluid;
wherein force that forces ions through the first wall faces is supplied by at least one of, movement of ions relative to a magnetic field, a channel pressure that is higher than pressure in the first hollow wall, and electrostatic attraction between the positive ions adjacent a positive face of the first wall and negative ions adjacent a negative face of the first wall, and wherein force that forces ions through the second I faces is supplied by at least one of, movement of ions relative to a magnetic field, a channel pressure that is higher than pressure in the second hollow wall, and electrostatic attraction between the positive ions adjacent a positive face of the second wall and negative ions adjacent a negative face of the second wall;
wherein at one of least of said wall faces is a ion-selective membrane;
allowing ion-concentrated fluid to exit the hollow walls; and
retaining at least partially deionized fluid in the channels.

21. A method for de-ionizing a fluid, comprising:
inputting fluid containing positive ions and negative ions in the at least three channels with a first hollow separating wall between the first channel and the second channel, and a second hollow separating wall between the second channel and the third channel;
using said fluid containing positive and negative ions and a magnetic field to cause positive ions in the first channel to move toward the first wall and to cause positive ions in the second channel to move toward the second wall, and to cause negative ions in e second channel to move toward the first wall and to cause negative ions in the third channel to move toward the second wall, wherein positive ions from the first channel are concentrated adjacent a positive face of the first wall and negative ions from the second channel are concentrate adjacent a negative face of the first wall, and wherein positive ions from the second channel are concentrated adjacent a positive face of the second wall and negative ions from the third channel are concentrated adjacent a negative face of the second wall; forcing negative ions from the second channel to pass through the first wall negative face into the first hollow wall and forcing positive ions from the first channel to pass through the first wall positive face into the first hollow wall, wherein the positive and negative ions mix in the first hollow wall and form ion-concentrated fluid; forcing negative ions from the third channel to pass through the second wall negative face into the second hollow wall and forcing positive ions from the second channel to ass through the second wall positive face into the second hollow wall, wherein the positive an negative ions mix in the second hollow wall and form ion-concentrated fluid; wherein force that forces ions through the first wall faces is supplied by movement of ions relative to a magnetic field and at least one of a channel pressure that is higher than pressure in the first hollow wall and electrostatic attraction between the positive ions adjacent a positive face of the first all and negative ions adjacent a negative face of the first wall, and wherein force that forces ion through the second wall faces is supplied by movement of ions relative to a magnetic field and at least one of a channel pressure that is higher than pressure in the second hollow wall and electrostatic attraction between the positive ions adjacent a positive face of the second wall and negative ions adjacent a negative face of the second wall;
allowing ion-concentrated fluid to exit the hollow walls; and
retaining at least partially de-ionized fluid in the channels.

22. A method for at least partially removing both anions and cations from a fluid, comprising:
inputting fluid containing positive ions and negative ions in the at least three channels with a first hollow separating wall between the first channel and the second channel, and a second hollow separating wall between the second channel and the third channel;
using said fluid containing positive and negative ions and at least one of a magnetic and a electrostatic field cause anions and cations to separate, such that positive ions in the first channel move toward the first wall and positive ions in the second channel move toward the second wall, and negative ions in the second channel move toward the first wall an negative ions in the third channel move toward the second wall, wherein positive ions from the first channel are concentrated adjacent a positive face of the first wall and negative ions from the second channel are concentrated adjacent a negative face of the first wall, and wherein positive ions from the second channel are concentrated adjacent a positive face of the second wall and negative ions from the third channel are concentrated adjacent a negative face of the second wall;
forcing negative ions from the second channel to pass through the first wall negative ace into the first hollow wall;
forcing positive ions from the first channel to pass through the first wall positive face into the first hollow wall, wherein the positive and negative ions in in the first hollow wall and form ion-concentrated fluid;
forcing negative ions from the third channel to pass through the second wall negative face into the second hollow wall and forcing positive ions from the second channel to pass through the second wall positive face into the second hollow wall, wherein the positive and negative ions mix in the second hollow wall and form ion-concentrated fluid; wherein force that forces ions through the first wall faces is supplied by at least one of, movement of ions relative to a magnetic field, a channel pressure that is higher pressure in the first hollow wall, and electrostatic attraction between the positive ions adjacent a positive face of the first wall and negative ions adjacent a negative face of the first wall, and wherein force that forces ions through the second wall faces is supplied by at least one of, movement of ions relative to a magnetic field, a channel pressure that is higher than pressure in the second hollow wall, and electrostatic attraction between the positive ions adjacent a positive face of the second wall and negative ions adjacent a negative face of the second wall, wherein at one of least one of said wall faces is an ion-selective membrane;
allowing ion-concentrated fluid to exit the hollow walls; and
retaining at least partially de-ionized fluid in the channels.
